(19) United States
(12) Patent Application Publication
(10) Pub. No.: US 2014/0331805 A1
(43) Pub. Date: Nov. 13, 2014

(54) GEARSHIFT ASSEMBLY

(71) Applicants: SL Corporation, Daegu (KR); Hyundai Motor Company, Seoul (KR)

(72) Inventors: Hee-Soo Yang, Busan (KR); Yang-Rae Cho, Suwon-si (KR); Jee-Hyuck Choi, Gunpo-si (KR); Chang-Hyun Lee, Seoul (KR); Ean-Soo Cho, Hwaseong-si (KR); Hyun-Woo Lee, Daegu (KR); Ju-Yeong Kim, Gyeongsan-si (KR)

(73) Assignees: SL Corporaiton, Daegu (KR); Hyundai Motor Company, Seoul (KR)

(21) Appl. No.: 14/140,431

(22) Filed: Dec. 24, 2013

(30) Foreign Application Priority Data
May 7, 2013 (KR) 10-2013-0051313

(51) Int. Cl. F16H 59/04

(52) U.S. Cl. CPC F16H 59/04
USPC 74/473.33

(57) ABSTRACT

A gearshift assembly structure includes: a gearshift knob including a knob core that has a insertion hollow formed lengthwise; a locking member installed on the knob core to pivot, the locking member having a locking protrusion formed on the outer surface of the locking member; and a gearshift rod to be inserted into the insertion hollow of the knob core, the gearshift rod having a locking groove formed on the outer surface thereof, wherein at the position the gearshift rod is fully inserted into the insertion hollow of the knob core, the locking member is received in the locking groove by pivoting the locking member inward.

### CROSS-REFERENCE TO RELATED APPLICATION

The present application claims priority of Korean Patent Application Number 10-2013-0051313 filed May 7, 2013, the entire contents of which application is incorporated herein for all purposes by this reference.

### BACKGROUND OF INVENTION

1. Field of Invention

The present invention relates to a gearshift assembly of vehicles, more particularly, to a gearshift assembly, capable of preventing the gearshift knob from being spoiled and improving labor efficiency in an assembly as well by improving a fastening structure of a gearshift knob that is locked to a top end of a gearshift rod.

2. Description of Related Art

A gearshift knob that is configured to feel comfortable and easy to grip in a driver's hands is mounted on an upper end of a gearshift rod that controls a transmission of vehicles. Such a gearshift knob is manufactured in various sizes and shapes to suit driver's preferences and features of the vehicles.

A conventional gearshift assembly structure is shown in FIGS. 1A and 1B.

Referring to FIG. 1A, a gearshift knob 1ain which an elastic clip 3 is pre-installed is pressed-in forcibly over a gearshift rod 2a in which a groove 4 is formed, to be assembled thereon. Referring to FIG. 1B, a male-screw thread 5 is formed on the outer peripheral surface at the top end of a gearshift rod 2b, and a female-screw thread to be meshed with the male-screw thread 5 is formed on the inner peripheral surface of a gearshift knob 1b.

In a configuration as shown in FIG. 1A, the elastic clip 3 that is enlarged elastically when the gearshift rod 2a is inserted into the gearshift knob 1a is restored elastically when the elastic clip 3 is disposed in the groove 4 of the gearshift rod 2a, to be seated thereon so that the gearshift knob 1a is assembled thereto. Meanwhile, in a configuration as shown in FIG. 1B, the gearshift knob 1b is rotated over the gearshift rod 2b for engaging the male-screw thread with the female-screw thread.

Additionally, according to the conventional gearshift assembly, in the case of the forcible press-in type as shown in FIG. 1A labor efficiency is decreased since it requires an excessive pressure on the gearshift knob 1a. Sometimes, workers use a tool like a rubber-hammer to reduce fatigue and it causes damage to the appearance of the gearshift knob. In the case of the screw-engagement type as shown in FIG. 1B, the gearshift knob is required to be rotated excessively and further the gearshift knob is loosened when it is assembled incompletely.

The information disclosed in this Background section is only for enhancement of understanding of the general background of the invention and should not be taken as an acknowledgement or any form of suggestion that this information forms the prior art already known to a person skilled in the art.

### BRIEF SUMMARY

The present invention has been made in an effort to solve the above-described problems associated with prior art. Various aspects of the present invention provide for a gearshift assembly structure which provides an improvement of assembly, enabling workers to assemble the gearshift knob to the gearshift rod with ease as well as preventing the gearshift knob from being spoiled in assembly.

Various aspects of the present invention provide for a gearshift assembly structure by which the gearshift knob can be replaced by another quickly and easily for repair or preferences of driver.

Various aspects of the present invention provide for a gearshift assembly structure, comprising: a gearshift knob including a knob core that has a insertion hollow formed lengthwise; a locking member installed on the knob core to pivot, the locking member having a locking protrusion formed on the outer surface of the locking member; and a gearshift rod to be inserted into the insertion hollow of the knob core, the gearshift rod having a locking groove formed on the outer surface thereof, wherein at the position the gearshift rod is fully inserted into the insertion hollow of the knob core, the locking member is received in the locking groove by pivoting the locking member inward.

According to various aspects of the present invention, the locking member further comprises a grip portion to pivot the locking member by hands.

According to various aspects of the present invention, the grip portion is configured to contact the outer surface of the knob core, when the locking protrusion is fully received in the locking groove.

According to various aspects of the present invention, the gearshift assembly structure further comprises a boot holder to lock the status of assembly by preventing the locking protrusion from popping out of the locking groove.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A is a perspective view including a partially sectional view thereof illustrating a gearshift assembly configured by pressing-in forcibly the gearshift knob in which an elastic clip is pre-installed over the gearshift rod in which a groove is formed, according to a related art;

FIG. 1B is a sectional perspective view illustrating a gearshift assembly configured by engaging the male-screw thread formed on an outer peripheral surface at the top end of the gearshift rod with the female-screw thread formed inside the gearshift knob, according to a related art;

FIG. 2 is a partially sectional view illustrating an exemplary gearshift knob and gearshift rod according to the present invention;

FIG. 3 is a partially sectional view illustrating an exemplary gearshift knob and gearshift rod prior to assembly and after assembly, respectively, according to the present invention;

FIG. 4 is a partially perspective view illustrating a pivotal movement of a clip of an exemplary gearshift knob according to the present invention;

FIG. 5A, FIG. 5B and FIG. 5C are partial views from the bottom illustrating a pivotal movement of a clip of an exemplary gearshift knob according to the present invention; and

FIG. 6 is a partially perspective view illustrating a boot holder coupled to a knob core of an exemplary gearshift knob according to the present invention.

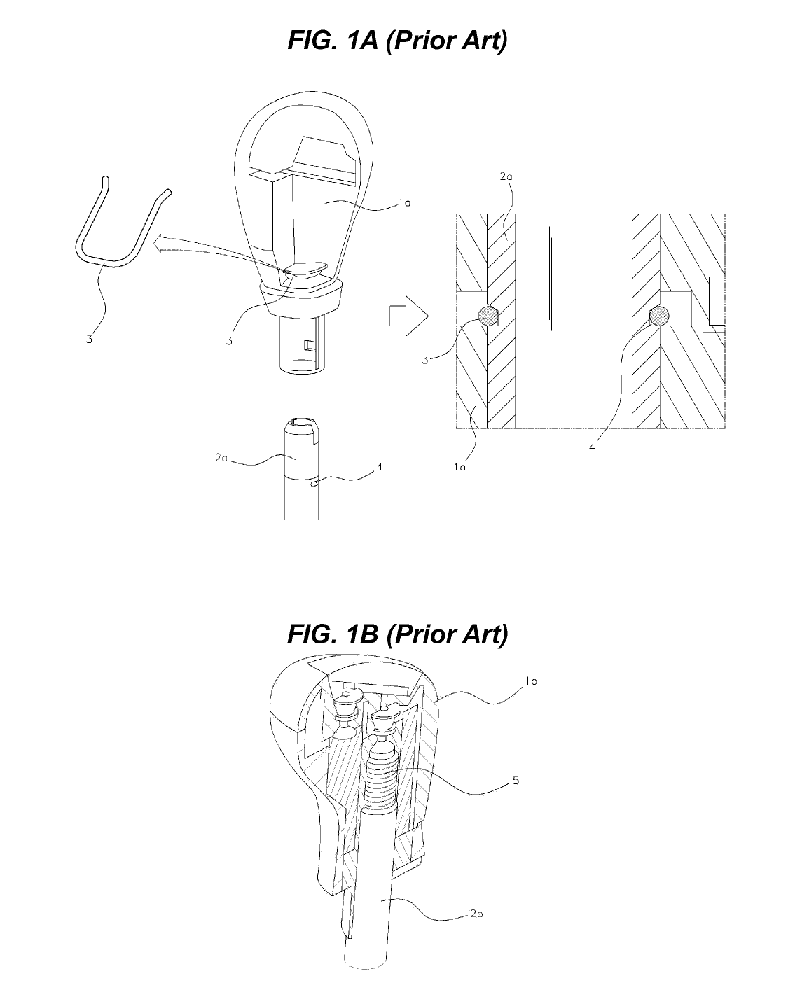

It should be understood that the appended drawings are not necessarily to scale, presenting a somewhat simplified representation of various features illustrative of the basic principles of the invention. In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter reference will now be made in detail regarding various embodiments of the present invention, examples of which are illustrated in the accompanying drawings and described below.

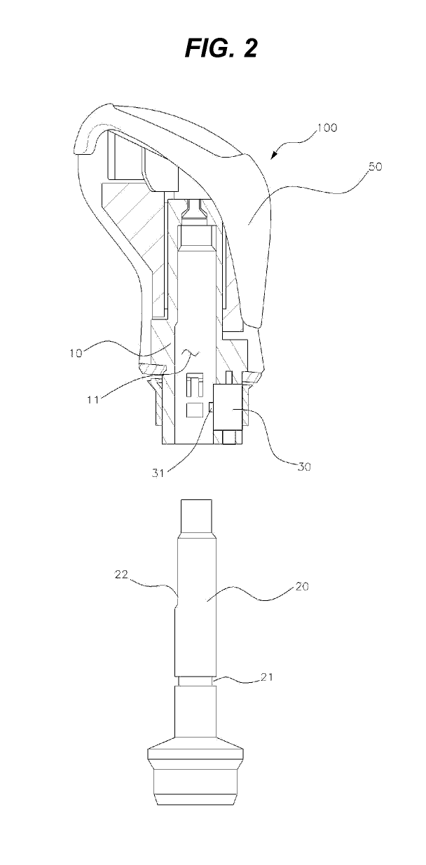

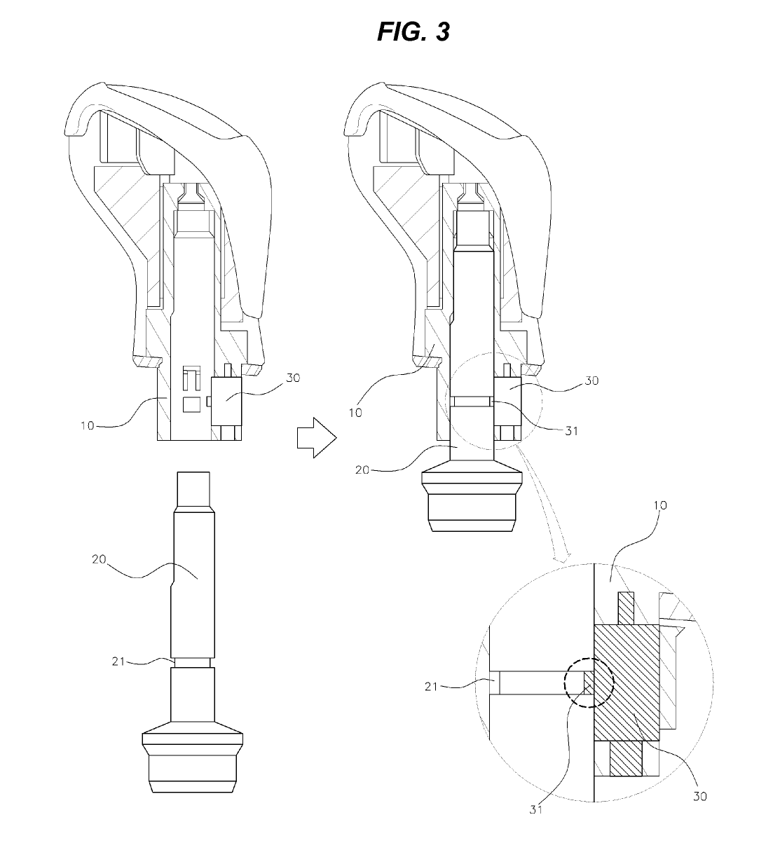

FIGS. 2 and 3 illustrate a gearshift knob and a gearshift rod in accordance with various embodiments of the present invention.

Referring to FIGS. 2 and 3, a gearshift knob 100 of the present invention includes a knob core 10 connected to the inside of a knob exterior 50 and a clip 30 connected pivotably to the knob core 10. The knob core 10 has a cylindrical shape having an insertion hole 11 formed lengthwise.

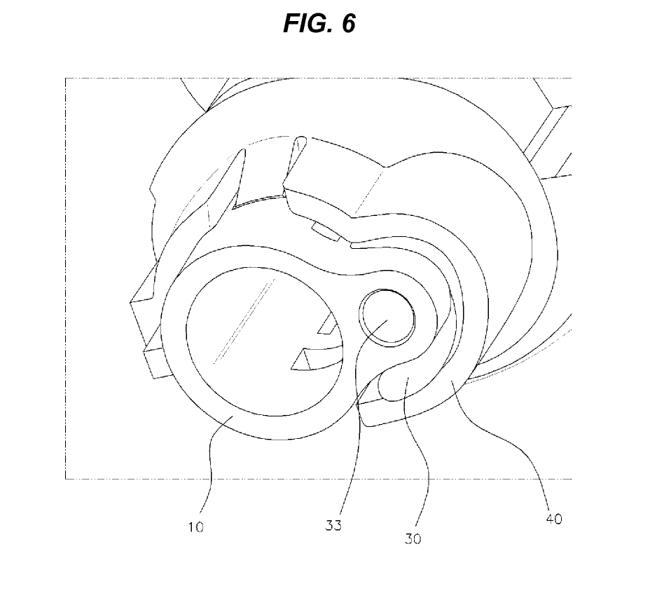

The clip 30 is installed pivotably to the knob core through a hinge pin (see 33, FIG. 6) such that both sides thereof are exposed to the inner peripheral surface and an outer peripheral surface of the knob core 10, respectively, and further a locking protrusion 31 having a predetermined height is provided on one side of the clip 30.

Meanwhile, a key-surface 22 cut in a predetermined shape is formed on one side of the gearshift rod 20 so as to prevent a rotation of the knob core 10 when the gearshift rod 20 enters completely into the insertion hole 11 of the knob core 10, and a locking groove 21 into which the locking protrusion 31 is fitted is formed below the key-surface, to a predetermined depth.

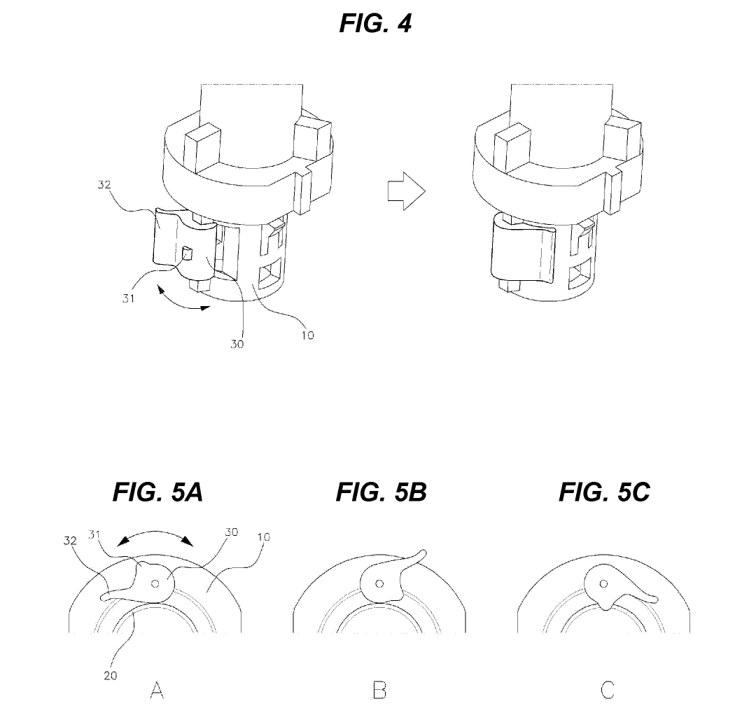

Furthermore, according to the gearshift assembly of the present invention, the gearshift knob 100 is assembled completely when the clip 30 is rotated such that the locking protrusion 31 is protruded toward the inside of the knob core 10 wherein a griper 32 to enable the worker to pivot the clip 30 more easily is formed additionally on the clip 30, as shown in FIG. 4.

With respect to the clip 30, as shown in FIG. 5A, the locking protrusion 31 is in a position directed toward the external part of the knob core 10 before the gearshift rod 20 is inserted into the knob core 10, and when the gearshift rod 20 is fully inserted into the knob core, the locking protrusion is fitted into the locking groove 21, as shown in FIG. 5C, through the state as shown in FIG. 2. According to various embodiments of the present invention, the clip 30 may be assembled to the gearshift rod 20 in a state of being pressed elastically, or the diameter of the clip becomes wider as it rotates (that is, the clip becomes in contact closely with a surface of the gearshift rod with stronger force), thereby preventing gap formation therebetween.

Further, in order to minimize a size protruding outside when the gearshift rod 20 is assembled, the griper 32 may be formed to face the outer surface of the knob core 10, when the clip 30 is rotated for the locking protrusion 31 to be fitted into the locking groove 21.

According various embodiments of the present invention, a boot holder 40 that is made of resilient material in an open-ring shape, as shown in FIG. 6, is installed to the knob core 10 to prevent the rotation of the clip 30 after the clip 30 is rotated for the locking protrusion 31 to be fitted into the locking groove 21.

According to the gearshift assembly of the present invention, the gearshift knob 100 can be prevented from being separated as the clip 30 rotates, and further the fastening force between the gearshift knob 100 and the gearshift rod 20 can be increased without a large press-in force required in the conventional gearshift assembly.

For convenience in explanation and accurate definition in the appended claims, the terms upper and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A gearshift assembly comprising:
a gearshift rod including a top end;
a gearshift knob including a lower part having an insertion hole, the top end of the gearshift rod inserted into the insertion hole of the gearshift knob;
a knob core including an insertion hole formed lengthwise therein;
a clip installed pivotably in the knob core, the clip including a locking protrusion formed on an outer peripheral surface of the clip; and
a gearshift rod inserted into the insertion hole fitted into the knob core and on an outer peripheral surface of which a locking groove is formed;
wherein when the gearshift rod is inserted into the knob core, the clip rotates for the locking protrusion to protrude toward an inside of the knob core and the locking protrusion is fitted into the locking groove.

2. The gearshift assembly of claim 1, wherein a griper protrudes from an outer peripheral surface of the clip.

3. The gearshift assembly of claim 2, wherein the gripper faces a surface of the knob core when the clip is rotated, for the locking protrusion to be fitted into the locking groove.

4. The gearshift assembly of claim 1, further comprising a boot holder to be installed on the knob core for preventing the rotation of the clip, when the clip is rotated for the protrusion to be fitted into the locking groove.

5. The gearshift assembly of claim 2, further comprising a boot holder to be installed on the knob core for preventing the rotation of the clip, when the clip is rotated for the protrusion to be fitted into the locking groove.

6. The gearshift assembly of claim 3, further comprising a boot holder to be installed on the knob core for preventing the rotation of the clip, when the clip is rotated for the protrusion to be fitted into the locking groove.
